(19) United States
(12) Patent Application Publication
(10) Pub. No.: US 2007/0148338 A1
(43) Pub. Date: Jun. 28, 2007

(54) Repair of natural damage during the production of wood comprising articles

(75) Inventor: Claes Magnus Dellrup, Södra Sandby (SE)

Correspondence Address: OLIFF & BERRIDGE, PLC, P.O. BOX 19928, ALEXANDRIA, VA, 22320, US

(73) Assignee: AKZO NOBEL COATINGS INTERNATIONAL B. V., Arnehem (NL)

(21) Appl. No.: 10/589,901

(22) PCT Filed: Mar. 1, 2005
(86) PCT No.: PCT/EP05/02260

§ 371 Date: Sep. 5, 2006

Related U.S. Application Data
(60) Provisional application No. 60/554,927, filed on Mar. 22, 2004.

(30) Foreign Application Priority Data
Mar. 11, 2004 (EP) 04075719.7

(51) Int. Cl. C08F 2/48

(52) U.S. Cl. 427/140; 427/508

(57) ABSTRACT

The present invention relates to a process for repairing one or more damaged spots in a wooden part during the production of a wood-comprising article, which repair process comprises the steps of: filling in at least one damaged spot in the, preferably uncoated, wooden part with a radiation-curable composition, placing a radiation-permeable layer over at least one damaged spot filled in with the radiation-curable composition, curing the curable composition in said at least one damaged spot by irradiation through the radiation-permeable layer, and removing the radiation-permeable layer.

The present invention relates to a process for repairing damage, sometimes called natural damage, in wooden parts used in the production of wood-comprising articles. The damage is repaired during the production of the articles, before the wood is further treated, for instance by application of a coating composition. Specifically, the present invention relates to the repair of wooden parts with damaged spots during the production of articles comprising wooden parts, for example coated solid wood, coated wooden planks, parquet planks, and veneer covered articles. The damage may be present in the wood before it is used or processed, and sometimes it appears during processing. For instance, knots may fall out when planks are sawn or when a veneer layer (usually a wooden layer having a thickness of 0.3 to 6 mm) is made. Other damage can be in the form of, for example, burls, cracks, torn away fibres, worm holes, splits, or parts of the wood that have fallen off or out during processing due to their bad quality.

The current practice is to repair damage in a wooden part during the production of wood-comprising articles by manually filling in the natural damage with a curable composition. The curable composition can, for example, be a water borne putty, a room temperature curing composition that comprises an epoxy-functional compound, a linoleum putty, a polyester putty, or a two-component putty with peroxide as hardener. Subsequently, the curable composition in the holes is allowed to cure or forced to cure. In a later stage, the outer surface of the wooden part is optionally sanded and subsequently coated. The top coating may, for example, be formed by applying and curing a UV curable acrylate coating composition.

A disadvantage of the above-described repair process is that it is performed manually. Filling in the holes by hand, using a putty machine, is a laborious process, expensive and time-consuming. This implies that this process is less suitable to be performed as a continuous repair process, for instance in a continuous production process. The total manual repair process, using a normal, relatively slow-curing composition, normally takes hours, while the planks may be produced at a continual flow of 1 to 20 boards width. The planks that need to be repaired are thus taken out of the on-line production stream, repaired, and then returned to the stream.

U.S. Pat. No. 4,894,971 describes a repair process in which a specially shaped bore is cut through a wooden part with a spot that needs to be repaired. A bore is cut with transverse dimensions that increase and decrease along the axis of the bore so that the repair filling in the bore becomes interlocked. This is a complicated and time-consuming process. Further, it is less suitable to be performed in a continuous repair process.

A disadvantage of the currently known repair processes in general is that the curing of compositions normally used to fill in the damage takes a relatively long time, normally about 5 minutes up to 24 hours. This implies that this process is less suitable to be performed as a continuous repair process, for instance in a continuous production process. Usually, the planks are put aside for the curing to take place and at a later stage the total surface is coated. The repaired panels described in the experimental section of U.S. Pat. No. 4,308,298, for example, were heated to about 170° C. for seven minutes and subsequently stored for 10 hours at a temperature above 18° C. before the repaired panels were sandable.

Consequently, there is a need for a repair process that does not have the above-mentioned disadvantages. The present invention relates to a process for repairing one or more damaged spots in a wooden part during the production of a wood-comprising article, which repair process comprises the steps of:
filling at least one damaged spot in the, preferably uncoated, wooden part with a radiation-curable composition,
placing a radiation-permeable layer over at least one damaged spot filled with the radiation-curable composition,
curing the radiation-curable composition in at least one damaged spot by irradiation through the radiation-permeable layer, and
removing the radiation-permeable layer.

The radiation-curable composition preferably is directly applied in the optionally sanded and optionally cleaned damaged spot. Cleaning may for example be performed using a brush, or a cloth. Alternatively, it is possible to remove some material out of the damaged spot before the radiation-curable composition is applied. It is also possible, but time consuming, to remove the damaged spot, or an area of a larger size than the damaged spot, so that a larger opening is obtained. The damaged spot may have caused a hole through the wooden part, for instance when a knot has fallen out, but it is not necessary to cut a bore through the wooden part.

It is absolutely not necessary to cut a bore through the wooden part with transverse dimensions that increase and decrease along the axis of the bore so that the repair filling in the bore becomes interlocked. It is not necessary to make such a specially shaped bore as the damaged spot is filled with a chemically curing system: a radiation-curable composition. Such compositions hardly shrink during curing, so the repair filling will not easily fall out.

The radiation-curable composition can have a viscosity, measured at room temperature, i.e. at about 25° C., in the range of from 15 to 1,000,000 mPa·s. All viscosities referred to in this document are Brookfield viscosities. Preferably the compositions has a viscosity in the range of from 10,000 to 1,000,000 mPa·s, more preferably in the range of from 10,000 to 500,000 mPa·s. The curable composition can be applied at room temperature. Alternatively, the composition is heated before application. A curable composition having a viscosity at 25° C. in the range of from 10,000 to 1,000,000 can, for instance, be heated to a temperature between 30 and 80° C. before it is applied to the damaged spot. The substrate comprising the damaged spot does not need to be heated. The composition preferably is thixotropic. For thixotropic compositions, the viscosities can be measured at high shear (when the final viscosity value at that shear has been reached). Very suitable compositions are thixotropic putties.

Before applying the coating composition in the damaged spot, it is in some cases possible to first apply an adhesion primer. The adhesion primer may be of any conventional type. It may be air drying, for example an acrylic comprising air drying primer, or UV curable. However, applying an adhesion primer would result in an additional process step. Further, it may be complicated to apply an adhesion primer to a damaged spot which has an uneven surface.

Preferably, a small excess of curable composition is applied to the damaged spot. Next, by means of pressure on the radiation-permeable layer, this surplus of curable material applied is spread out over a small area around the damaged spot. This results in a smooth transition between the top surface of the wooden part and the repaired area.

This process has various advantages. It requires less time, as the repair composition can be cured in a relatively short time, i.e. in a few seconds when a normal UV lamp or a flash unit is used and in half a minute up to a few minutes when a so-called daylight cure lamp is used. For example, if a plank is taken out of an on-line production stream to be repaired off-line, it can be returned to the production stream much quicker than is the case with the normally used repair methods.

Another advantage is that a part or the whole of the repair process can be automated. For example, using a fully automated repair process according to the present invention, the total repair process of a plank during the production of parquet planks produced at a continuous flow of 1 to 6 boards width can be performed in a few minutes. Hence, one or more damaged spots in a plank can be repaired on-line; the plank does not have to be taken out of the on-line production stream. A partly or fully automated repair process according to the present invention can be part of a continuous production process for the production of wood-comprising articles.

Additionally, the use of a process for repairing a wooden part with one or more damaged spots during the production of a wood-comprising article in which the damaged is filled in with a curable composition and then covered by a radiation-permeable layer and subsequently cured has an advantage over processes where such a radiation-permeable layer is absent. It is now possible to obtain a good quality repair while using a radiation-curable composition in the repair process. Since the radiation-curable composition is covered with a film during curing, curing takes place under a reduced amount of oxygen. The inert atmosphere under the film ensures that the coating cures more easily. Additionally, a more durable cured material with improved (mechanical) properties is obtained as compared to conventional putties cured without being covered by a film.

Another advantage of the process according to the invention is that good levelling can be obtained. When some pressure is applied to the radiation-permeable layer on the filled in damaged spot, the curable composition is levelled with the surface of the substrate just around the damaged spot. This makes later processes, such as sanding of the repaired substrate, easier. It also reduces the risk that the repair coat will be accidentally removed from the damaged spot during sanding.

Other advantages of the present invention, which will be elaborated below, are that the process requires a relatively small amount of photoinitiators and that a relatively high amount of pigments can be present in the curable composition.

A process according to the present invention is suitable to repair damage in wooden parts, especially damage in wooden layers, more especially in flat wooden layers. A process according to the present invention is very suitable to repair damage in wooden parts that will be coated at a later stage. The repaired substrates can, for example, be overcoated with a standard UV sealer and/or with a standard UV top coat, a 100% solids UV-curable composition, with polyester, polyurethane, nitrocellulose, an acid curing coating composition, a one- or two-component water borne system, a water borne UV-curable system, or any hybrid system of these. It was found that damaged spots repaired with a radiation curable system can be much easier overcoated with a UV-curable system than damaged spots that were repaired with a linseed oil comprising putty. The UV-curable systems adhere better to areas that were repaired with a UV-curable composition than areas that were repaired with a linseed oil comprising putty.

Another advantage of using a radiation curable composition for the repair and a UV-curable composition for the overcoating is that both the repair and the overcoat can be cured at a high speed.

The repaired, and optionally overcoated, wooden parts can be used in the production of wood-comprising articles such as parquet planks, (coated) wooden flooring, solid wooden flooring, furniture, solid wooden furniture, window frames, and articles covered with a (coated) veneer layer, for instance furniture such as office furniture, kitchen cabinets, kitchen tables, and the like.

For example, the damage in the wooden layer of parquet planks may need to be repaired during production. Parquet planks consist of a sandwich structure. The plank may have a total thickness of, for instance, 8-30 mm. The lower layer or one or more of the lower layers supply strength and thickness to the parquet plank. These layers can be made of materials such as paper, medium density fibre board (MDF), high density fibre board (HDF), wafer board, flake board, chip board, particle board, plywood or sheet pine.

The top of the sandwich structure normally comprises a wooden layer that has been coated with one or more coating layers. The wooden layer usually is a very thin layer, for example 0.3-6 mm, and during its production knots may fall out and other damage show up. The stage at which the damage, such as knot holes, is repaired is usually when the wooden layer has been applied on top of a lower layer or on top of a pile of two or more lower layers. At a later stage, the total surface of the plank may be sanded, a sealer may be applied to the surface of the wooden layer, the total surface of the plank may be (re)sanded, and then the total surface is coated, usually with several layers of coating material.

In the process according to the present invention, the curable composition applied to the damage can be a conventional UV-curable composition, for instance a UV-curable composition having a low volatile organic content (VOC), i.e. less than 450 grams solvent per liter, or preferably less than 420 grams solvent per liter of the composition. It is not necessary for the composition in the holes to show very good adhesion properties. Nor does it need to have a very good appearance, as another coating layer will be applied on top of the repair coat when the whole plank is top coated/finish coated.

Preferably, the curable composition comprises less than 40 wt. % volatile organic compounds, more preferably less than 30 wt. %. Most preferred are curable compositions comprising less than 5 wt. % of volatile organic compounds. The composition can also contain up to 60 wt. % water, calculated on the total weight of the curable composition. Most preferred are compositions comprising less than 5 wt. % water.

If the curable composition comprises a volatile organic compound and/or water, this should be evaporated after the application of the composition to the damage, before the film is placed on top of the uncured composition. The amount of volatile organic compound and/or water should not be such that as a result of the evaporation the surface of the uncured composition sinks so much that it will still be seen after sanding and finish coating of the surface of the wooden part at a later stage. Reactive diluents can be used instead of (part) of any water and/or volatile organic compounds, for example to adjust the viscosity of the curable composition. A reactive diluent usually is a monomer or a mixture of monomers that reacts with one or more of the other components in the composition. Well-known diluents are acrylic diluents, e.g., tripropylene glycol diacrylate (TPGDA), hexanediol diacrylate (HDDA), acrylated pentaerythritolethoxylate (PPTTA), and hydroxyethyl methacrylate (HEMA).

The use of reactive diluents reduces or eliminates VOC emission, as they are incorporated into the final film. However, they are known for their skin irritant and sensitising properties. Further, these components often have a strong or unpleasant odour and are suspect in view of their toxic properties. A further problem when coating porous substrates, e.g., wood, with compositions comprising reactive diluents is the penetration of the reactive monomers into the pores of the substrate. This is a drawback in particular when the coating is cured by radiation. Since the radiation does not reach these areas, uncured coating material in the pores of the substrate is the result. This can give health, safety, and environmental problems, e.g., when the substrate is cut or sanded. Release of free monomers from porous panels is known to occur even years after the lacquer has been applied. If the curable composition comprises a reactive diluent, it is preferably present in a small amount.

Highly preferred are so-called 100% solids UV-curable compositions, i.e. compositions comprising less than 3 wt. % volatile organic compounds and less than 2 wt. % water. High solids systems and so-called 100% solids systems usually comprise a reactive diluent. Such a diluent reacts during curing and hardly evaporates. Preferably, the curable composition comprises less than 20 wt. %, more preferably less than 15 wt. % monomers. Highly preferred are compositions comprising less than 10 wt. % or even less than 5 wt. % of monomers.

Hot melt compositions are very suitable in the process of the invention. The hot melt composition preferably has a low volatile organic content, i.e. less than 450 grams per liter, or preferably less than 420 grams per liter. Most preferably, the hot melt composition is a so-called 100% solids composition, i.e. a composition comprising less than 3 wt. % volatile organic compounds and less than 2 wt. % water. Preferably, the hot melt composition comprises less than 20 wt. %, more preferably less than 15 wt. % monomers. Highly preferred are hot melt compositions comprising less than 10 wt. % or even less than 5 wt. % of monomers. Preferably, the hot melt composition has a viscosity, measured at room temperature, i.e. at about 25° C., in the range of from 10,000 to 1,000,000 mPa·s, more preferably in the range of from 10,000 to 500,000 mPa·s. Before application to the damaged spot in a process according to the present invention, the hot melt composition is preferably heated to a temperature in the range of from 30 to 100° C., more preferably in the range of from 40 to 90° C., most preferably in the range of from 40 to 80° C.

In a process according to the present invention, preferably a two-component curable system is used. This may be a dual cure system in which a slower secondary curing mechanism takes place that makes it possible to obtain a good through-cure, which is especially of importance when relatively deep damage is repaired. For instance, a isocyanate composition can be added to a UV-curable composition; preferably the isocyanate composition is highly viscous. In this case a post-cure of the isocyanate groups can take place. Examples of suitable isocyanates are Desmodur L 75, Desmodur L 67%, Desmodur Z 4470 BA, Desmodur N 3390, Desmodur N-75, Desmodur N-100%, Desmodur HL 60% I BUA, Desmodur E 21, Desmodur VL, Desmodur Z 4370, Desmodur L 67 BuAc, Desmodur N 3600, Desmodur HL 60% BuAC (all ex Bayer), and Tolonate HDB 75 MX (ex Rhodia). The isocyanate composition added to the UV-curable composition may comprise one or more isocyantes.

Alternatively, one or more types of secondary amines can be added to a UV-curable composition. After irradiation, the amines can react with the possibly present uncured double bonds. Examples of suitable amine-functional compounds are aminoethyl ethanolamine, aminoethyl piperazine, α,ω-diaminopropylene glycol (Jeffamine D400), diethylene triamine, dipropylene triamine, trimethylhexane(1,6)diamine (mixture of 2,2,4 and 2,4,4 isomers), and 3-aminopropyltriethoxysilane (Dynasil AMEO-T ex Hüls).

Also one or more peroxy systems can be added to a UV-curable composition. In this case the UV curing of acrylates can be the second curing mechanism. Examples of suitable peroxides are Cyclonox LR, Cyclonox 11, Cyclonox LE-50 (all ex Akzo Nobel). The peroxy system(s) added to the UV-curable composition may comprise one or more peroxides.

Alternatively, silanes, e.g. moisture curable silanes, or thio-functional curing agents can be added to a UV-curable composition.

Even more preferably, a three-component curable system is used. This may be a triple curing system in which a slower secondary and a slower ternary curing mechanism takes place that makes it possible to obtain a good through-cure, which is especially of importance when a relatively deep damage is repaired or when a part of the curable system is not reached by the UV-light (shadow area). Especially suitable is a UV-curable composition to which one or more peroxides and one or more secondary amine-functional compounds are added. Also especially suitable is a UV-curable composition to which one or more peroxides and one or more isocyanates are added. The peroxides, secondary amines and isocyanates that are listed above as suitable for a two-component system are also suitable for a three-component system.

After covering a filled in damaged spot with a radiation-permeable layer and (partial) curing of the composition by radiation through the layer, the relatively slow secondary curing may continue during the further processing of the wooden part. Obtaining a good through-cure via a dual cure system is very advantageous in view of the risks associated with any monomers, i.e. unreacted reactive diluent, that may be present in the damaged spot after irradiation of the curable composition. When monomers (which did not react during the first curing) take part in the secondary reaction, the presence of free monomers in the repaired areas of the final product is reduced or even eliminated.

The curable composition may comprise oligomers or resins with a medium or relatively high molecular weight, for instance radiation-curable oligomers or resins having a viscosity in the range of from 15 to 1,000,000 mPa·s at ambient temperature, i.e. between 5 to 40° C. Preferably, the curable composition comprises about 50 up to 100 wt. %, more preferably 85 to 100 wt. %, even more preferably 90 to 100 wt. % of oligomers or resins having a viscosity in the range of from 10,000 to 1,000,000 mPa·s, preferably from 10,000 to 500,000 mPa·s at ambient temperature. Clear compositions preferably comprise between 80 and 99, more preferably between 90 and 95 wt. % of oligomers or resins. Lightly pigmented compositions, having for instance a yellowish, reddish, or brownish colouring, comprise between 80 and 99, more preferably between 90 and 95 wt. % of oligomers or resins. Highly pigmented compositions, comprising for example up to 40 wt. % pigments, preferably comprise above 40 wt. %, more preferably above 60 wt. % of oligomers or resins.

The curable composition used in the process according to the present invention is radiation-curable. Within the framework of the present invention, a radiation-curable composition is a composition which is cured using electromagnetic radiation having a wavelength λ≦500 nm or electron beam radiation. An example of electromagnetic radiation having a wavelength λ≦500 nm is UV radiation. Radiation sources which may be used are those customary for electron beam and UV. For example, UV sources such as high-, medium-, and low-pressure mercury lamps can be used. Also, for instance, gallium and other doped lamps can be used, especially for pigmented compositions. It is also possible to cure the composition by means of short light pulses and daylight curing.

Compared to processes in which a radiation-permeable layer is absent, it appeared that radiation having a lower energy than that emitted by conventional UV sources can be used to achieve acceptable curing. This effect might be due to the radiation-permeable layer on top of the composition preventing the initiated radicals from being caught by oxygen in the air. Hence, in one embodiment of the present invention, especially when curing clear coats, the composition is cured using low-energy UV sources, i.e. by so-called daylight cure. The intensity of these lamps is lower than that of the aforementioned UV sources. Low-energy UV sources emit hardly any UV C; they predominantly emit UV A, and radiation with a wavelength at the border of UV B and UV A.

Preferably, the composition is cured by radiation having a wavelength of 200 nm≦λ≦500 nm, more preferably 200 nm≦λ≦450 nm. For some compositions low-energy UV sources emitting radiation having a wavelength of 370 nm≦λ≦450 nm may be preferred. One advantage of using a radiation source emitting radiation having a wavelength of 200 nm≦λ≦500 nm is that it is safer to use than conventional UV sources, which emit a relatively high amount of UV C and/or UV B. Another advantage is that daylight cure lamps are less expensive than conventional UV lamps. Commercially available daylight cure lamps are, for instance, solarium-type lamps and specific fluorescent lamps such as TL03, TL05 or TL09 lamps (ex Philips) and BLB UV lamps (ex CLE Design). As an example of a commercially available daylight cure lamp that emits short light pulses the mercury-free UV/VIS flash lamps of Xenon may be mentioned.

Most conventional lamps have an output of between 80 and 120, or up to 240 W/cm. Another type of lamp that is very suitable in a process according to the current invention is a lamp with an output in the range of 20 to 240 W/cm. In the case of a lamp with a large output range, the output, and thus the amount of energy used, can be adjusted with the production speed. Preferred is a lamp with an output in the range of 20-120 W/cm. Especially when using tinted systems in a process according to the invention, the cure can be performed using both a mercury lamp and a gallium lamp. The use of radiation from a gallium lamp has been found to result in a deep cure/good through-cure of systems.

The curable composition sandwiched between the substrate and the radiation-permeable layer is cured by irradiation through this layer. If the composition is cured by electron beam, the material of the radiation-permeable layer is not critical, since penetration by the electrons can be ensured by selecting a sufficiently high voltage. Consequently, in the case of cure by electron beam, this layer can comprise, e.g., aluminium foil or an aluminised layer, for instance an aluminised polyester film, plastic or paper.

If the curable composition is to be cured by UV radiation, the radiation-permeably layer has to be sufficiently transparent to the UV radiation. In the case of cure by (low) UV radiation, the radiation-permeable layer can comprise quartz glass or glass plate or a polymeric material, for example polycarbonate, modified polycarbonate (e.g. plexiglass), polyvinyl chloride, acetate, polyethylene, polyester, an acrylic polymer, polyethylene naphthalate, polyethylene terephthalate or polycarbonate, and co-polymers thereof. The radiation-permeable layer can be rigid or flexible, and may be of any desired thickness, as long as it permits sufficient transmission of the radiation used to result in a sufficient cure of the composition. The radiation-permeable layer does not have to have a very smooth surface at the side facing the curable composition in the damaged spot when the repaired wooden part is overcoated at a later stage during the production of the wood-comprising article.

Ideally, a composition is chosen which, after cure, shows good release properties from the radiation-permeable layer. When there is good release, the radiation-permeable layer can be removed from the repaired wooden part with the repair composition staying in the damaged spot(s). The curable compositions used in a process according to the present invention are suitable to be combined with a wide range of radiation-permeable layer types, including untreated radiation-permeable layers. In order to ensure good release properties from the radiation-permeable layer, the radiation-permeable layer may be treated. The type of treatment used should be adjusted to the type of radiation-permeable layer and the type of curable composition used in the repair process according to the present invention. The radiation-permeable layer can for instance be coated with a release coating. Such a release coating may contain silicone or a fluoropolymer such as polytetrafluoroethylene as release agent. U.S. Pat. No. 5,037,668, for instance, describes a silicone-free fluoropolymer comprising an acrylate-type release coating.

Polyester acrylate oligomers and resins were found to be very suitable for use in the curable composition with which the damaged spot is filled in in the process according to the present invention. Examples of suitable commercially available polyester acrylate resins are: Craynor® UVP-215, Craynor® UVP-220 (both ex Cray Valley), Genomer® 3302, Genomer® 3316 (both ex Rahn), Laromer® PE 44F, Laromer PE 56F, Laromer 8992, Laromer 8800 (ex BASF), Ebecryl® 800, Ebecryl® 810, Viaktin® 5979, Viaktin® VTE 5969, and Viaktin® 6164 (100%) (all ex UCB).

Epoxy acrylate oligomers and resins were also found to be very useful in the curable composition in the process according to the present invention. Examples of commercially available epoxy acrylate resins are: Craynor® UVE-107 (100%), Craynor® UVE-130, Craynor® UVE-151, CN® 104 (all ex Cray Valley), Actilan 300, Actilan 320, Actilan 330, Actilan 360 (all ex Akzo Nobel), Photocryl® 201 (ex PC resins), Genomer® 2254, Genomer® 2258, Genomer® 2260, Genomer® 2263 (all ex Rahn), UVP® 6000 (ex Polymer technologies), and Ebecryl® 3500 (ex UCB).

Polyether acrylate resins can also be used in the curable composition in the process according to the present invention. Examples of commercially available polyether acrylate resins are: Genomer® 3456 (ex Rahn), Laromer® PO33F (ex BASF), Viaktin® 5968, Viaktin® 5978, and Viaktin® VTE 6154 (all ex Vianova).

Urethane acrylate oligomers and resins can also be used in the curable composition in the process according to the present invention. Examples of commercially available urethane acrylate resins are: CN® 934, CN® 936, CN® 976, CN® 981 (all ex Cray Valley), Ebecryl® 210, Ebecryl® 230, Ebecryl® 270, Ebecryl® 2000, Ebecryl® 8800 (all ex UCB), UA VPLS® 2308, UA VPLS® 2989 (both ex Bayer), Genomer® 4258, Genomer® 4652, and Genomer® 4675 (all ex Rahn).

Other examples of radiation-curable oligomers and resins that can be used in the curable composition with which the damaged spot is filled in in the process according to the present invention are cationic UV curable resins, for instance cycloaliphatic epoxide resins such as Uvacure® 1500, Uvacure® 1501, Uvacure® 1502, Uvacure® 1530, Uvacure® 1531, Uvacure® 1532, Uvacure® 1533, and Uvacure® 1534 (all ex UCB Chemicals), Cyracure® UVR-6100, Cyracure® UVR-6105, Cyracure® UVR-6110, and Cyracure® UVR-6128 (all ex Union Carbide), or SarCat® K126 (ex Sartomer), acrylate modified cycloaliphatic epoxides, caprolactone based resins such as SR® 495 (=caprolactone acrylate, ex Sartomer), Tone® 0201, Tone® 0301, Tone® 0305, Tone® 0310 (all caprolactone triols, ex Union Carbide), aliphatic urethane divinyl ether, aromatic vinyl ether oligomer, bis-maleimide, diglycidyl ether of bisphenol A or other glycols, hydroxy-functional acrylic monomer, hydroxy-functional epoxide resin, epoxidised linseed oil, epoxidised polybutadiene, glycidyl ester or partially acrylated bisphenol A epoxy resin, or trimethylol propane oxetane (UVR® 6000, ex Union Carbide).

Other radiation-curable compounds that are suitable to be used in the curable composition in the process according to the present invention are, e.g., vinyl ether-containing compounds, unsaturated polyester resins, acrylated polyetherpolyol compounds, (meth)acrylated epoxidised oils, (meth)acrylated hyperbranched polyesters, silicon acrylates, maleimide-functional compounds, unsaturated imide resins, compounds suitable for use in photo-induced cationic curing, or mixtures thereof.

In the radiation-curable composition also use may be made of a radiation-curable mixture of (a) photo-induced radical curing resin(s) and (b) photo-induced cationic curing resin(s). Such systems are sometimes called hybrid systems and may comprise, for example, acrylic oligomers as photo-induced radical curing resins, vinyl ethers as photo-induced cationic curing resins, and radical and cationic photoinitiators. In principle, all possible combinations of photo-induced radical curing resins and photo-induced cationic curing resins can be used in such hybrid systems.

Also non-radiation-curable polymers can be incorporated into the curable composition. These polymers can be used to modify the viscosity, tack, adhesion, or gelling properties of the curable formulation and/or to modify the general physical properties of the cured material, such as stain resistance, flexibility or adhesion. Examples are Cellulose Acetate Butyrate (various grades, ex Eastman), Laropal materials, (ex BASF), Paraloid materials, (ex Rohm and Haas), Degalan LP 65/12 (ex Degussa), and Ucar materials (ex Union Carbide). In general, the curable composition used in the process according to the present invention comprises 0 to 20 wt. % non-radiation-curable polymers.

Further, the composition can comprise a photoinitiator or a mixture of photoinitiators. Examples of suitable photoinitiators that can be used in the radiation-curable composition according to the present invention are benzoin, benzoin ethers, benzylketals, α,α-dialkoxyacetophenones, α-hydroxyalkylphenones, α-aminoalkylphenones, acylphosphine oxides, benzophenone, thioxanthones, 1,2-diketones, and mixtures thereof. It is also possible to use copolymerisable bimolecular photoinitiators or maleimide-functional compounds. Co-initiators such as amine based co-initiators can also be present in the radiation-curable curable composition. Examples of suitable commercially available photoinitiators are: Esacure® KIP 100F and Esacure® KIP 150 (both ex Lamberti), Genocure® BDK, Genocure® CQ, Genocure® CQ SE, Genocure® EHA, Velsicure® BTF, Quantacure® BMS, Quantacure® EPD (all ex Rahn), Speedcure® EDB, Speedcure® ITX, Speedcure® BKL, Speedcure® BMDS, Speedcure® PBZ, Speedcure® BEDB, Speedcure® DETX (all ex Lambson), Cyracure® UVI-6990, Cyracure® UVI-6974, Cyracure® UVI-6976, Cyracure® UVI-6992 (all ex Union Carbide), CGI-901, Irgacure® 184, Irgacure® 369, Irgacure® 500, Irgacure® 754, Irgacure® 819, Darocur® 1000, Darocur® 1173 (all ex Ciba Chemicals), and Lucirin® TPO (ex BASF).

However, the presence of a photoinitiator is not necessary. In general, when electron beam radiation is used to cure the composition, it is not necessary to add a photoinitiator. When UV radiation is used, in general a photoinitiator is added, but UV curing can also be performed without a photoinitiator. When present, the total amount of photoinitiator in the composition is not critical; it should be sufficient to achieve acceptable curing of the composition when it is irradiated. However, the amount should not be so large that it affects the properties of the cured composition in a negative way. In general, the composition should comprise between 0 and 10 wt. % of photoinitiator, calculated on the total weight of the composition.

As a rule, compared to the amount necessary when the composition is applied to a substrate and subsequently cured, in the process according to the present invention a smaller amount of photoinitiator can be used to achieve acceptable curing. This effect might be due to the radiation-permeable layer on top of the curable composition, as the radiation-permeable layer may reduce the amount of initiated radicals caught by oxygen in the air. Most photoinitiators have an unpleasant or strong odour. Therefore, one advantage of using only a small amount of photoinitiator, or no photoinitiator at all, is that the composition has a more pleasant smell.

The composition can also contain one or more fillers or additives. The fillers can be any fillers known to those skilled in the art, e.g., barium sulphate, calcium sulphate, calcium carbonate, silicas or silicates (such as talc, feldspar, and china clay). Additives such as aluminium oxide, silicon carbide, for instance carborundum, ceramic particles, glass particles, stabilisers, antioxidants, levelling agents, anti-settling agents, anti-static agents, matting agents, rheology modifiers, surface-active agents, amine synergists, waxes, or adhesion promoters can also be added. Also paint driers, such as cobalt carboxylate, e.g. Cobalt Siccatol (ex Akcros chemicals), can be added. It was found that two-component curable systems and three-component curable systems to which cobalt carboxylate was added were very suitable.

In general, the curable composition used in the process according to the present invention comprises 0 to 60 wt. % of fillers and/or additives, calculated on the total weight of the curable composition.

The radiation-curable composition used in the process according to the present invention can also contain one or more pigments. In principle, all pigments known to those skilled in the art can be used. However, care should be taken that the pigment does not show a too high absorption of the radiation used to cure the composition. In general, the curable composition comprises 0 to 50 wt. % of pigment, preferably 1-40 wt. % of pigment, calculated on the total weight of the curable composition. Because of the radiation-permeable layer on top of the composition that reduces the amount of initiated radicals being caught by oxygen in the air, acceptable curing of a pigmented composition can be reached even when the composition comprises a relatively large amount of pigments.

The detection of damage in a wooden part that needs to be repaired can be automated, for example by means of a camera and a computerised detecting program. For instance, Woodeye® (ex Innovativ Vision AB) may be used.

Equipment known to those skilled in the art can be used to apply the curable composition to the damaged spot, e.g., a syringe, a heated or non-heated gun, a rod, or a spout.

In an alternative embodiment, the curable composition is applied using a roller coater. This is especially suitable for substrates comprising a large number of small damaged spots. In such a case the part of the substrate comprising a number of small damaged spots, or even the complete surface of such a substrate, can be coated using a roller coater. Next, the film is applied and some pressure is applied to the film. This results in the small damaged spots being filled in and a levelled coated surface at the same time.

When a substrate comprises one or more relatively large damaged spots as well as a number of relatively small damaged spots, the large damaged spot(s) can be repaired separately, e.g. by filling them in using a syringe, a heated or non-heated gun, a rod, or a spout, followed by applying a film and curing with radiation through the film, whereas the small damaged spots can be repaired using a roller coater, a film, and radiation. The large damaged spot(s) can be repaired before, at the same time as, or after the repair of the small damaged spots.

Application of the curable composition to the damaged spot can be performed manually or automatedly. For instance, a robot with a gun with heated or non-heated nozzles connected to a camera system may be used to apply the curable composition. After application of the radiation-permeable layer, equipment known to those skilled in the art can be used to smoothen the curable layer underneath the radiation-permeable layer, e.g., a rod or a roller coater.

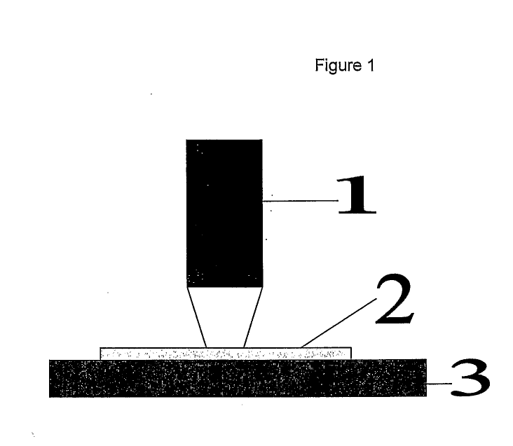

The radiation-permeable layer used in the process may be relatively rigid and preferably can be reused repeatedly. When repairing a wooden part for a wood-comprising article that has several damaged spots, it is possible to use one or more small pieces of a radiation-permeable layer each covering one or a few damaged spots. The radiation-permeable layer may even cover the whole surface of the damage-containing wooden part. A relatively rigid radiation-permeable layer that can be reused is useful in a continuous process, especially in a process in which flat wooden layers are repaired. An example is presented in FIG. 1. Referring to FIG. 1, a UV light source 1 is shown which is placed above a plexiglass layer 2 and a substrate 3.

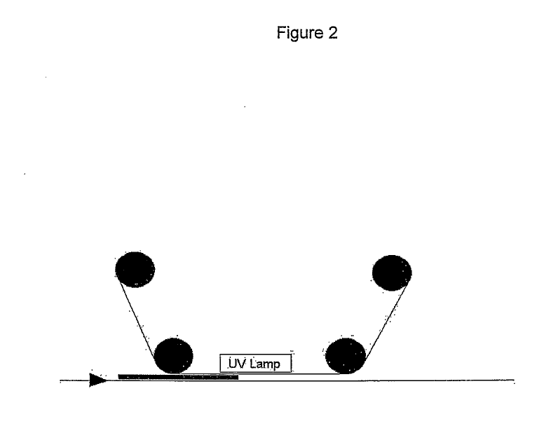

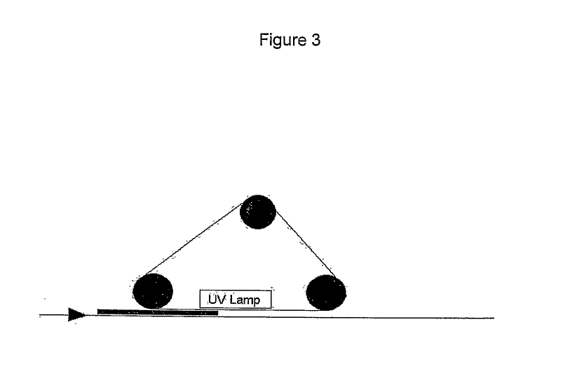

Alternatively, the radiation-permeable layer may be flexible. It can be a small piece of film, or a large piece of film that covers several damaged spots or even the entire surface of the damage-containing wooden layer. The flexible film may be a reel of film that can be reused. Such a reel of film can be useful in a continuous process, especially in a process in which flat wooden layers are repaired. Such a reel may comprise one or more loops. Examples of such reels are presented in FIGS. 2 and 3. FIG. 2 illustrates a cross-section of a substrate that is placed on a conveyer belt. The film is delivered from a reel and rewound on another reel. A UV lamp is place above the piece of film that is parallel to the substrate. The curable composition in the damaged spot(s) is cured by irradiation from the UV lamp while the film is still in contact with the composition. FIG. 3 illustrates a cross-section of a substrate placed on a conveyer belt, a continuous reel of film, and a UV lamp. The UV lamp is placed in the reel, above the substrate.

In a preferred continuous repair process according to the present invention, the damaged spots detected by means of an automated system are filled in by means of an automated system, the curable composition is optionally dried and subsequently covered with the radiation-permeable layer, which preferably has a size sufficient to cover several damaged spots, the curable composition in the holes is cured by irradiating the composition through the radiation-permeable layer, followed by removal of the radiation-permeable layer.

The invention will be elucidated with reference to the following examples. These are intended to illustrate the invention but are not to be construed as limiting in any manner the scope thereof.

All viscosities mentioned in the examples are Brookfield viscosities. For thixotropic compositions, the viscosities were measured at high shear (when the final viscosity value at that shear was reached). The viscosity measurements were performed with Brookfield RV, speed 1 and spindle 2.

### EXAMPLES

Several compositions suitable for use in a process according to the present invention were prepared according to the following formulations.

Formulation 1 (UV-curable system)

| Component | Amount in wt. % |
|---|---|
| Polyester acrylate | 86 |
| Aromatic urethane acrylate | 10 |
| Photoinitiator combination | 4 |

UV-curable compositions according to Formulation 1 had a viscosity of about 20,000 mPa·s at room temperature. Compositions according to Formulation 1 were heated to 40° C. before application.

Formulation 2 (UV-curable system)

| Component | Amount in wt. % |
|---|---|
| Aliphatic urethane acrylate | 96 |
| Photoinitiator combination | 4 |

UV-curable compositions according to Formulation 2 had a viscosity of about 150,000 mPa·s at room temperature. Compositions according to Formulation 2 were heated to 60° C. before application. radiation.

Formulation 3 (lightly tinted UV-curable system)

| Component | Amount in wt. % |
|---|---|
| Polyester acrylate | 86 |
| Aromatic urethane acrylate | 10 |
| Photoinitiator combination | 4 |
| Pigment | 0.025 |

Lightly tinted compositions according to Formulation 3 had a viscosity of about 20,000 mPas at room temperature. Compositions according to Formulation 3 were heated to 40° C. before application.

Formulation 4 (highly tinted UV-curable system)

| Component | Amount in wt. % |
|---|---|
| White pigment paste | 35 |
| Filler | 20 |
| Aromatic epoxy acrylate | 20 |
| Photoinitiator combination | 3.5 |
| Acrylated pentaerythritol ethoxylate | 20 |
| Additive (defoamers, wetting agents, etc.) | 1.5 |

Highly tinted compositions according to Formulation 4 had a viscosity of 3,000 mPas at room temperature. Compositions according to Formulation 4 were heated to 25° C. before application.

Formulation 5 (dual cure system)

| Component | Amount in wt. % |
|---|---|
| Aromatic epoxy acrylate | 72 |
| Aromatic urethane acrylate | 10 |
| Photoinitiator combination | 3 |
| Acrylated amine | 15 |

Dual cure compositions according to Formulation 5 had a viscosity of about 370,000 mPa·s at room temperature. The compositions according to Formulation 5 were heated to 80° C. before application. Compositions prepared according to Formulation 5 are partly curable by UV radiation while, as slower secondary curing mechanism, amine groups are present that can react with double bonds, especially with the double bonds that remain uncured after UV.

Formulation 6 (dual cure system)

| Component | Amount in wt. % |
|---|---|
| Epoxy-acrylate | 20 |
| Epoxy-acrylate | 44 |
| Methacrylate | 3 |
| Photoinitiator combination | 7 |
| Rheology modifier | 4 |
| Additive | 2 |
| Acrylated amine | 20 |

Formulation 10 (cobalt comprising dual cure system)

| Component | Amount in wt. % |
|---|---|
| Epoxy-acrylate | 24 |
| Epoxy-acrylate | 53 |
| Methacrylate | 3 |
| Photoinitiator combination | 9 |
| Rheology modifier | 5 |
| Additive (including Co) | 2 |
| Peroxide system | 4 |

A peroxide was added as a secondary curing agent to the formulations to ensure good through cure also in shadow areas not reached by the UV light. Compositions according to Formulation 10 had a viscosity of about 13,000 mPa·s at room temperature.

Formulation 11 (pigmented cobalt comprising dual cure system)

| | Amount in |
|---|---|
| Component | wt. % |
| Polyester acrylate | 52 |
| Polyether triacacrylate | 39 |
| Photoinitiator combination | 1 |
| Rheology modifier | 4 |
| Cobalt | 0.035 |
| Pigment | 0.025 |
| Peroxide system | 4 |

Compositions according to Formulation 11 had a viscosity of about 13,000 mPa·s at room temperature.

Formulation 12 (cobalt comprising triple cure system)

| | Amount in |
|---|---|
| Component | wt. % |
| Epoxy-acrylate | 21 |
| Epoxy-acrylate | 48 |
| Methacrylate | 3 |
| Photoinitiator combination | 8 |
| Rheology modifier | 5 |
| Additives (including Co) | 2 |
| Peroxide system | 4 |
| Isocyanate | 9 |

Formulation 7 (pigmented cobalt comprising dual cure system)

| Component | Amount in wt. % |
|---|---|
| Polyester acrylate | 44 |
| Polyether triacacrylate | 32 |
| Photoinitiator combination | 1 |
| Rheology modifier | 3 |
| Cobalt | 0.03 |
| Pigment | 0.02 |
| Acrylated amine | 20 |

An amine-functional curing agent was added as a secondary curing agent to the formulations to ensure good through cure also in shadow areas not reached by the UV light.

Compositions according to Formulation 6 and 7 had a viscosity of about 13,000 mPa·s at room temperature.

Formulation 8 (dual cure system)

| Component | Amount in wt. % |
|---|---|
| Epoxy-acrylate | 22 |
| Epoxy-acrylate | 50 |
| Methacrylate | 3 |
| Photoinitiator combination | 9 |
| Rheology modifier | 5 |
| Additive | 2 |
| Isocyanate | 9 |

An isocyanate was added as a secondary curing agent to the formulations to ensure good through-cure also in shadow areas not reached by the UV light.

Formulation 9 (pigmented cobalt comprising dual cure system)

| Component | Amount in wt. % |
|---|---|
| Polyester acrylate | 49 |
| Polyether triacacrylate | 36 |
| Photoinitiator combination | 1 |
| Rheology modifier | 4 |
| Cobalt | 0.035 |
| Pigment | 0.025 |
| Isocyanate | 10 |

Both isocyanate and peroxide were added to a UV-curable system to ensure good through cure also in shadow areas not reached by the UV light.

Formulation 13 (pigmented cobalt comprising triple cure system)

| | Amount in |
|---|---|
| Component | wt. % |
| Polyester acrylate | 48 |
| Polyether triacrylate | 35 |
| Photoinitiator combination | 1 |
| Rheology modifier | 4 |
| Cobalt | 0.035 |
| Pigment | 0.025 |
| Isocyanate | 8 |
| Peroxide system | 4 |

Compositions according to Formulation 13 had a viscosity of about 13,000 mPa·s at room temperature.

Formulation 14 (cobalt comprising triple cure system)

| | Amount in |
|---|---|
| Component | wt. % |
| Epoxy-acrylate | 18 |
| Epoxy-acrylate | 42 |
| Methacrylate | 3 |
| Photoinitiator combination | 7 |
| Rheology modifier | 4 |
| Additives (including Co) | 2 |
| Peroxide system | 4 |
| Acrylated amine | 20 |

Both peroxide and an amine-functional agent were added to a UV-curable system to ensure good trough cure also in shadow areas not reached by the UV light.

Formulation 15 (pigmented cobalt comprising triple cure system)

| | Amount in |
|---|---|
| Component | wt. % |
| Polyester acrylate | 42 |
| Polyether triacacrylate | 31 |
| Photoinitiator combination | 1 |
| Rheology modifier | 3 |
| Cobalt | 0.03 |
| Pigment | 0.02 |
| Peroxide System | 4 |
| Acrylated amine | 19 |

Compositions according to Formulation 14 and 15 had a viscosity of about 13,000 mPa·s at room temperature.

Compositions according to Formulations 8 to 13 had a high viscosity; they were like putties. These compositions showed thixotropic behaviour. It was not possible to obtain a stable viscosity measurement value for compositions according to Formulations 8 to 13. The compositions according to Formulations 6 to 15 were not heated; they were applied at room temperature.

All compositions according to Formulations 1 to 15 were (where applicable after heating to the required temperature) applied by hand, heated or non-heated gun or roller coater. The compositions were applied to one or more damaged spots in a wooden layer during the production of parquet, solid wooden furniture, furniture comprising a veneer layer, and/or solid wooden planks.

After application of the curable compositions to the damaged spots, a radiation-permeable film or plexiglass was placed on the filled in damaged spot(s). The compositions were subsequently cured by UV radiation or flash or daylight UV through the film. In some experiments, a system as presented in FIG. 2 or a system as presented in FIG. 3 was used.

The curable compositions prepared according to Formulations 1 to 4 showed good deep curing properties. The curable compositions prepared according to Formulations 5 to 15 showed very good deep curing properties and proved to be very suitable to repair relatively deep damage. All repaired substrates proved to be easy to sand.

The cured compositions in the damaged spots, and on the substrates in case of roller coater application, showed a good optical appearance after recoating with a standard UV sealer and a standard UV top coat. The obtained repaired substrates were also suitable to be overcoated with any other industrial coating, e.g. polyester, polyurethane, nitrocellulose, an acid curing coating composition, a one- or two-component water borne system, a water borne UV-curable system, or any hybrid system of these.

Especially knot holes repaired with pigmented compositions looked natural.

1. Process for repairing one or more damaged spots in a wooden part during the production of a wood-comprising article, which repair process comprises the steps of:
filling in at least one damaged spot in the, preferably uncoated, wooden part with a radiation-curable composition,
placing a radiation-permeable layer over said at least one damaged spot filled in with the radiation-curable composition,
curing the radiation-curable composition in said at least one damaged spot by irradiation through the radiation-permeable layer, and
removing the radiation-permeable layer.

2. A process according to claim 1, wherein the radiation-curable composition is directly applied in the optionally sanded and optionally cleaned damaged spot.

3. A process according to claim 1, wherein it comprises a further step in which the repaired wooden part is overcoated.

4. A process according to claim 3, wherein the repaired wooden part is overcoated with a UV curable composition.

5. A process according to claim 1, wherein the damaged spot(s) is/are filled in with a UV curable composition.

6. A process according to claim 1, wherein the damaged spot(s) is/are filled in with a dual cure composition.

7. A process according to claim 1, wherein the curable composition with which the damaged spot is filled in is a curable composition comprising less than 40 wt. % volatile organic compounds.

8. A process according to claim 1, wherein the curable composition with which the damaged spot is filled in is a curable composition comprising less than 20 wt. % reactive diluent.

9. A process according to claim 1, wherein a small excess of curable composition is applied, and that after the radiation-permeable layer is placed over the uncured composition the surplus of curable material applied to the damaged spot is spread out over a small area around the damaged area by means of pressure on the radiation-permeable layer.
